(19) United States
(12) Patent Application Publication
(10) Pub. No.: US 2004/0027414 A1
(43) Pub. Date: Feb. 12, 2004

(54) Printing on surfaces

(76) Inventors: Miguel Boleda, San Diego, CA (US); John H. Oleinik, Camas, WA (US); Erik Estrem, Sherwood, OR (US)

Correspondence Address: LADAS & PARRY, Suite 2100, 5670 Wilshire Boulevard, Los Angeles, CA, 90036-5679, US

(21) Appl. No.: 10/218,202

(22) Filed: Aug. 12, 2002

(51) Int. Cl. B41J 23/00

(52) U.S. Cl. 347/37

(57) ABSTRACT

In a method of printing an image on a surface, a printing system is employed which comprises a static base unit and a printing device which is moved in passes over the surface, the position of the printing device being monitored and being controlled so that printing occurs only at locations on the surface where printing has not yet been completed. The base unit and printing device have respective antennae which enable the position of the printing device on the surface to be always known. The base unit and printing device are interconnected by a flexible tube incorporating data, power and ink connections. The flexible tube may also convey pressurized air to produce an air cushion which maintains the printing device at a constant spacing from the surface to the printhead. Printing may occur in two phases, firstly with a relatively large printing device and then with a relatively small printing device to fill in the gaps in coverage of the surface.

### BACKGROUND OF THE INVENTION

The present invention relates to a printing system for printing on surfaces, and especially to a system for printing on relatively large surfaces such as walls. It also relates to a method of printing on such surfaces.

U.S. patent application Ser. No. 09/428,681 filed on Oct. 27, 1999 (the contents of which are hereby incorporated by reference) discloses a handheld inkjet printing mechanism for printing a selected image on a print surface of a solid body or a semi-flexible body, comprising a chassis, a controller supported by the chassis, with the controller storing the selected image therein, an inkjet printhead supported by the chassis to selectively eject inkjet ink onto the print surface in response to the controller, and a printhead-to-print surface spacing device to control the spacing between the printhead and the print surface, with the spacing device being supported by the chassis to traverse over the print surface when moved therealong by an operator while the printhead selectively ejects ink onto the print surface to record the selected image thereon. The mechanism further includes a positional monitoring device supported by the chassis to generate a positional signal for the controller to indicate the position of the printhead relative to the print surface when moved therealong by the operator. The positional monitoring device may comprise an optical sensor or a rotary encoder wheel supported by the chassis to roll along the print surface during said movement by the operator. With this printing mechanism, printing operations occur in single passes.

### SUMMARY OF THE INVENTION

Aspects of the present invention seek to provide a method for producing an accurate and complete image over a surface even when an operator is unable to ensure accuracy of passes of the printing device over the surface. The printed image may consist partially or wholly of text and the term “image” is to be construed accordingly in this specification.

According to a first aspect of the present invention, there is provided a printing system comprising a printing device, including at least one printhead movable over a surface, and a base unit, each of said printing device and said base unit incorporating respective electromagnetic antennae, said antennae forming part of a position sensing system whereby the position of said printing device relative to said surface can be determined.

Preferably, said position sensing system also determines the orientation of said printing device relative to said surface.

According to a second aspect of the present invention, there is provided a printing system for providing an image on a surface, said system comprising at least one printhead moveable over said surface, a monitoring arrangement, said monitoring arrangement being arranged to monitor the position of said printhead as it passes over said surface, and a controller, said controller being connected to said position monitor and being arranged to control operation of said printhead whereby said printhead only prints on regions of said surface where printing of said image has not yet been completed.

Preferably, the printing system is portable.

According to a third aspect of the present invention, there is provided a method of printing an image on a surface by passing at least one printhead over said surface, monitoring the position of said printhead as it is passed over said surface, and controlling operation of said printhead so that it prints when it is at a location where printing of said image has not yet been completed but does not print when it is at a location where printing of said image has been completed.

The printhead is preferably moved manually over the surface.

In preferred embodiments both the location and the orientation of said printhead are taken into account when controlling its operation, This has the advantage of achieving accurate printing even if a printing pass is in the wrong location or at the wrong orientation relative to an adjacent pass.

In one method, a plurality of printheads is passed over said surface, printing by a first of said printheads occurring during a first pass over a region of said surface and printing by one or more further printheads occurring during respective subsequent passes over said region. Each said printhead may print a respective color and such an arrangement avoids bleeding of the different-colored inks. Alternatively the printheads may print simultaneously during a single pass.

In one method, in a first phase a first printhead is passed over at least part of said surface to be printed to print part of the image and, in a second phase, a second printhead is passed over at least part of the surface to be printed to print parts of the image not printed by the first printhead during the first phase. Preferably, said second printhead is able to reach regions of the surface to be printed which said first printhead cannot reach. For example, said second printhead may be smaller than said first printhead. Similar position monitoring arrangements are preferably provided for said first and second printheads and they have a common control so that the regions can be identified which are to be printed by said second printhead. More than two printheads may be used in a corresponding number of phases in such an arrangement.

According to a fourth aspect of the present invention, there is provided a printing system for printing an image on a surface, the system comprising at least first and second printing devices moveable over said surface at different times, means for monitoring the position of each printing device as it passes over said surface, and control means connected to said position monitoring means and controlling operation of said printing devices so that, in a first phase, said first printing device is passed over at least part of said surface to be printed to print part of the image, and, in a second phase, said second printing device is passed over at least part of the surface to be printed to print part of the image.

Preferably in both phases printing only occurs at locations where printing of the image has not yet been completed.

According to a fifth aspect of the present invention, there is provided a movable device comprising a print zone including at least one printhead, a first barrier surrounding said print zone a second barrier spaced from and surrounding said first barrier to form a region between said first and second barriers, and an air supply device, said air supply device being arranged to supply pressurized air to said region whereby to produce an air cushion capable of maintaining said printing device at a substantially constant distance from a surface to be printed.

### BRIEF DESCRIPTION OF THE DRAWINGS

Preferred embodiments of the present invention will now be described, by way of example only, with reference to the accompanying drawings, of which:

FIG. 1 shows a perspective view of a printing system in accordance with a first embodiment of the present invention;

FIG. 2 shows an enlarged perspective view of a hand-held device of the system of FIG. 1;

FIG. 3 is a graph showing the variation with distance from the surface to be printed of the force created by an air-cushion of the device of FIG. 2;

FIG. 4 shows an image which a user wishes to print on a wall in a method according to the invention;

FIG. 5 shows a first printing pass of a printing device in accordance with the method of FIG. 4;

FIG. 6 shows the region of the image of FIG. 4 printed by the printing pass of FIG. 5;

FIG. 7 shows a second printing pass of the printing device superimposed on the first printing pass of FIG. 5;

FIG. 8 shows the regions of the image of FIG. 4 printed by both the printing passes of FIG. 7;

FIG. 9 shows a side view of a hand-held device of a system in accordance with a second embodiment of the present invention; and

FIG. 10 is a top plan view of the device of FIG. 9.

### DESCRIPTION OF THE PREFERRED EMBODIMENTS

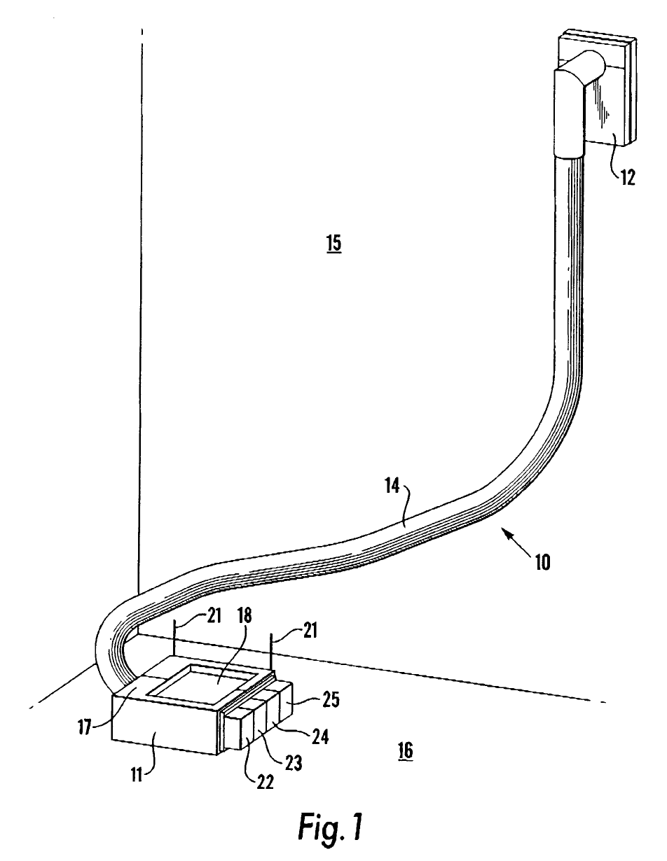

Referring to the drawings, FIG. 1 shows a printing system 10 comprising a base unit 11 and a movable printing device 12 interconnected by a length of flexible tubing 14. As shown, printing device 12 is arranged to be manually held against a vertical wall surface 15 and base unit 11 is placed on a convenient adjacent horizontal surface 16.

Base unit 11 comprises a top surface 17 having a recess 18 of a size and shape to receive device 12 when it is not in use. The edges of the recess are arranged to seal around or cap the printing device 12 to restrict the evaporation of ink therefrom. The bottom surface of the recess 18 comprises means (not shown) for cleaning the device 12.

The base unit 11 further comprises two antennae 21 for receiving positional data from device 12. Circuitry for calculating the position of device 12 from the electromagnetic signals received by antennae 21 are also included in unit 11.

Unit 11 also encloses ink reservoirs or cartridges 22-25 for black and three colours. Unit 11 further houses a motor and fan arrangement (not shown) for producing an air stream. Unit 11 also has a memory for storing an image to be printed. A processor within unit 11 is used to determine, from the positional information received by antennae 21 and from the stored image, the printing instruction signals to be sent to printheads of device 12.

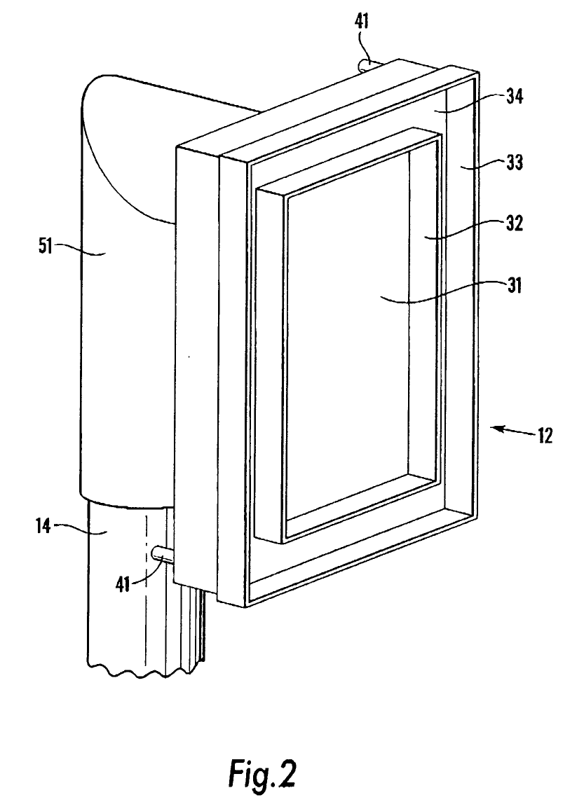

The printing device 12, shown on an enlarged scale in FIG. 2 comprises a print zone 31 including a plurality of printheads (not shown). The print zone 31 has a peripheral wall 32, which is surrounded at a spacing by a further wall 33. The free edges of walls 32 and 33 are substantially coplanar. The front surface 34 of device 12 between the walls 32 and 33 is provided with a plurality of orifices (not shown) which, as described below, are arranged to produce an air cushion.

The printing device further comprises two antennae 41 for transmitting electromagnetic signals indicating position to the antennae 21 of the base unit 11. The circuitry within base unit 11 employs interferometry or triangulation to calculate the position and orientation of the print device 12 on wall 15.

The printing device 12 also has a hollow tubular portion 51 extending from its back which serves as a manual grip by which a user can hold the device and guide it over wall 15. Tubular portion 51 also constitutes the connection of device 12 with tubing 14.

The flexible tubing 14 is used to carry ink, power, pressurized air and printing data from the base unit 11 to the printing device 12. Ink is conveyed by means of four respective lines from the print reservoirs 22-25 to corresponding printheads in the print zone 31. One or more power lines extending along tubing 14 provide power for firing the printheads. An air tube passing through tubing 14 connects the motor and fan arrangement within base unit 11 to the orifices in surface 34 of printing device 12 to provide an air cushion within the space between walls 32 and 33.

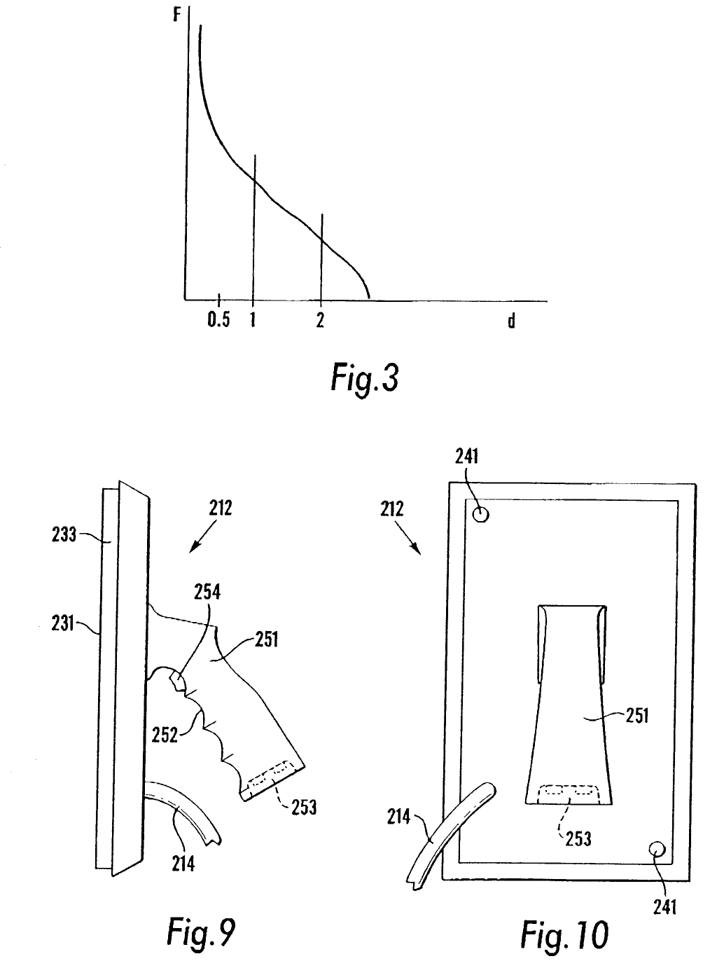

The air cushion technique consists in delivering pressurized air to the printing side of the handheld device 12. The walls 32,33 contain the pressurized air and allow it to escape only through the spacing between their edges and the wall 15 to be painted FIG. 3 is a graph illustrating the principle of operation of this technique.

In FIG. 3, F is the force created by the air cushion as a function of the clearance (d) between edges of walls 32 and 33 of the handheld device 12 and the wall 15. As can be seen, the force increases substantially when attempting to “seal” the handheld device against the wall. In normal operation, pressure (or operator force) variations have only a small effect on the distance variation. This keeps the print quality to its maximum level.

Flexible tubing 14 further includes a plurality of data lines which carry printing instructions from the control circuitry of base unit 11 to a printhead control system in device 12 to cause the printheads to print the desired image in accordance with the current position and orientation of device 12.

In use, data representing a desired image are loaded into the memory of base unit 11. In the present case, the simple example of a tea cup is used. With the base unit 11 in a fixed location on surface 16, an initiation procedure is undertaken so that the system can determine the size and position of the image to be printed. For example, with device 12 being successively placed at the four corners of wall 15, means can be actuated to cause the control circuitry to identify the co-ordinates of the points with the antennae 21,41. Device 12 is manually held against an arbitrary portion of wall surface 15 and means are then operated to begin actual printing.

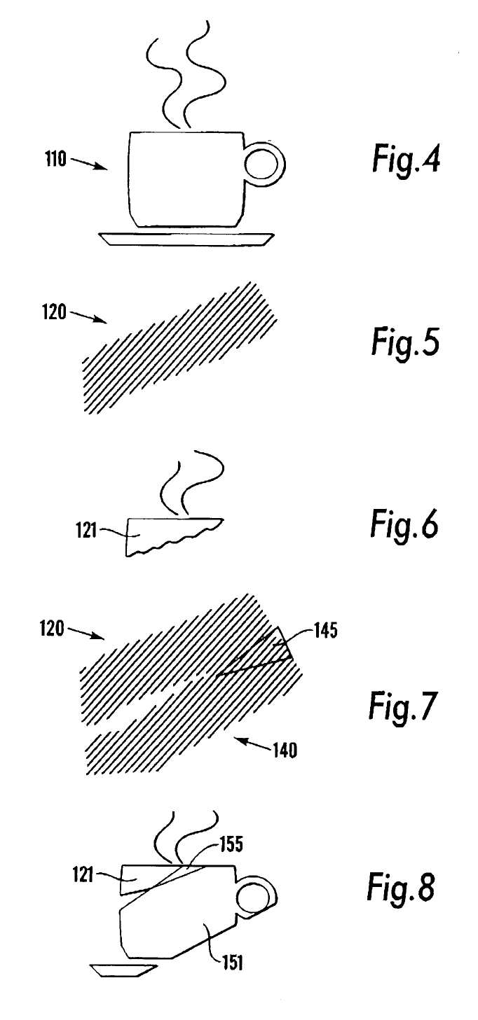

FIG. 4 represents the image 110 of a tea cup which the user wishes to paint or print on the surface of a wall. The ink ejection is controlled by the processor of the base unit 11 which, using the positioning feedback information from the position sensing arrangement, calculates the part of the image 110 to be printed during respective passes of the printheads over the surface. Thus printing commands to fire ink are issued as the device 12 is moving.

FIG. 5 represents a first pass 120 of the printheads as the user sweeps device 12 along the wall. FIG. 6 represents the corresponding region 121 of image 110 which is actually printed on the wall during the first pass as calculated by the processor. In the present case, this is the top left of the cup.

The user then moves the printing device 12 to an adjacent area of free wall and sweeps it as represented in FIG. 7 to produce a second swath or pass 140. The processor calculates the relevant region 151 of the image and prints it as shown in FIG. 8. Where the passes 120 and 140 overlap, i.e. in region 145, no ink is ejected during the second pass. By applying successive swaths of the wall-printing device along the wall, covering all the area, the complete image is formed If the user retraces on an area that is partially painted, no ink will be fired on the already painted zones, just on the non-painted zones.

The above-described arrangement has numerous advantages. In particular, the user does not need to be precise in sweeping the printing device 12 over the wall. It does not matter if adjacent passes are at an angle to each other, or if that are of different lengths or if they overlap. Also, it does not matter if successive passes leave gaps therebetween provided that, by the finish of the printing operation, all of the required regions of the surface have been covered. The device 12 can be lifted away from the wall 15 during a printing operation and subsequently placed against a different location on the wall. The position sensing arrangement enables the correct part of the image to be selected and printed. Accordingly, the image can be produced by an unskilled operator.

The printing process can be effected very quickly, so that a large wall surface can be covered in a short period of time. It has a high throughput and a low set-up time, The use of an air cushion has the advantage of reducing the drying time of the ink. By providing the air cushion around but separate from the print zone 31, there is no interference with the ink ejection process from the printheads due to air pressure variations.

Thus the process provides a convenient alternative to wall-papering a room without the need to accurately place the different sheets of paper. Advantages over conventional painting of a room are that paint brushes, rollers and solvents are not required and the image is easy to renew or replace. Any desired image and/or text can be supplied to the processor of the device for printing and customized according to the customer's desires. Large patterns or posters can be printed. The system is portable so that it can be easily transported to remote sites.

Various modifications may be made to the above described arrangement. For example, the position of the printing device can be determined using electromagnetic transmitters on the base unit 11 with receivers located on the device 12. The system may comprise three transmitters and three receivers which permit position monitoring in three dimensions, thus allowing relatively complicated shaped areas to be covered. The base unit 11 can incorporate both transmitters and receivers with a reflector arrangement being mounted on the device 12.

In other alternatives, optical encoder systems may be used to determine position as disclosed in the above-mentioned co-pending application U.S. Ser. No. 09/428,681. In another modification the position is determined using a sensor similar to that used for tracking ball-free mouse devices. This sensing arrangement includes a CCD sensor, illumination means and an optical path to capture successive images of the surface on which the device is moving. By comparing two consecutive images with image processing means, it is possible to determine the direction and space travelled during the movement.

Instead of being rectangular, the air cushion may be formed by a circular region around the print zone 31.

The printing device may be maintained at a constant distance from the wall surface by means of wheels or a skid arrangement, both of which are disclosed in the above-mentioned co-pending application U.S. Ser. No. 09/428,681.

Other types of printers beside ink-jet printers may be employed.

In another modification, the technique is applied to multipass printing where more than one pass of the printheads over a certain area is required. In this case, at a first pass over a zone, the printheads will only fire a fraction of the ink drops necessary to form a full image. On successive passes of the printheads over the same zone, the remaining ink drops will be fired until the image is complete.

Taking the printing of image 110 in a two pass printmode as an example in a first pass half of the ink drops are fired in a pattern identical to region 121. In a second pass, in the region 140 where no ink was deposited during the first pass, half of the drops are fired in image region 151. However, in the overlap region 145 the complementary drops are fired, so that region 155 of the image is already complete. In successive passes, the full image is printed.

In the production of multi-color images, printing in the color planes may occur simultaneously or in successive passes depending upon the ink drying time for the material of the wall surface and the danger of bleeding. The device 12 can have a single printhead for monochrome printing.

The technique can be used to print on any desired surface including those of containers, vehicles, boats or parts of the human body.

In another method according to the invention, a combination of two printing devices is employed. The printing system comprises a first, relatively large, high productivity printing device with a PWA (page wide array) of printheads and a corresponding base unit comprising a CPU, a service station for the printheads and ink supply means. The array and the unit are connected by tubing means for delivering ink and a trailing cable for supplying data and power. This first device 12 is used to print images on relatively large and flat surfaces.

The second printing device is relatively small, comprising a printhead with a single chamber for the or each color, and has low productivity. However, it is versatile so that it can produce images on more complex surface regions and on regions which are difficult to access and which the first printing device is unable to cover. The first device is initially used to cover the regions of the surface which it can accurately cover, and the second device is then used to print in the regions not printed by the first device.

The two devices have similar position sensing means and the base unit of the system is connected to the second device to provide printing commands for the regions not printed by the first device. The devices may have different shapes, e.g. rectangular and triangular, in addition to, or instead of, being of different sizes.

Three or more sizes of printing devices can be used for a wider range of applications.

Finishing effects like stucco may be achieved by arrangements in accordance with the invention. With three-dimensional inkjet printing technology, low-relief images may be printed to create custom three-dimensional drawings having any shape or any surface.

Referring now to FIGS. 9 and 10 there is shown a hand-held device 212 of a system in accordance with a second embodiment of the present invention. Similarly to device 12 of the first embodiment, device 212 has a print zone 231 comprising a plurality of printheads (not shown) surrounded by two walls between which is produced an air cushion. The rear of the device has a handle 251 with a grip portion 252, a battery compartment 253 and a finger-operated switch 254. Device 212 also comprises two antennae 241 which, supplied with power from a battery in compartment, transmit signals used in a position sensing arrangement in an associated base unit (not shown). Tubing 214 is connected between the base unit and the rear of device 212 and conveys ink, pressurised air, data representing printing instructions and power for firing the printheads.

The printing device 212 is employed in a similar manner to that of device 12 of the first embodiment. When it is desired to commence printing, the device 212 is placed against the surface of a wall etc. and the user then operates switch 254. Printing can be interrupted at any stage by releasing switch 254. Device 212 can be removed from the printing surface, e.g. for cleaning or servicing the printheads or allowing the user to rest, and can be placed against any location on the surface for printing to recommence.

Various modifications may be made to the above-described second embodiment. For example, switch 254 may be located at any convenient position on device 212. In other modifications, one or more batteries in compartment 253 may also provide power to fire the printheads within print zone 231 and/or to produce the air cushion. Alternatively, or in addition, the ink supply for the printheads may be incorporated (e.g. in the form of ink cartridges) in the device 212 itself. The above modifications have the advantage of reducing the number of lines extending along tubing 214, but increase the weight of device 212.

In yet a further modification, tubing 214 can be omitted completely and the printing instructions to the printheads may also be transmitted electromagnetically. This is particularly advantageous if device 212 is used as the smaller, second device in the two-device system described above. If device 212 has no tubing to restrain its movements it can reach otherwise inaccessible regions.

The features and modifications of the first and second embodiments may be interchanged as desired. In the case of both embodiments, the image produced may be one large picture or a repeating pattern. Although the devices 12,212 disclosed are moveable by hand, an automated device may be arranged to move them over surface 15.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims- and their equivalents-in which all terms are meant in their broadest reasonable sense unless otherwise indicated.

What is claimed is:

1. A printing system comprising a printing device, including at least one printhead movable over a surface, and a base unit, each of said printing device and said base unit incorporating respective electromagnetic antennae, said antennae forming part of a position sensing system whereby the position of said printing device relative to said surface can be determined.

2. A printing system according to claim 1, wherein said position sensing system also determines the orientation of said printing device relative to said surface.

3. A printing system according to claim 1, further including a processor coupled to said position sensing system, and a print controller, said print controller being arranged to actuate said at least one printhead, said processor being coupled to operate said print controller whereby said at least one printhead only prints on parts of said surface where printing has not yet been completed.

4. A printing system according to claim 3, wherein said printing device and said base unit are interconnected by an elongate flexible connection.

5. A printing system according to claim 4, wherein said connection includes a data connection link between said processor and said print controller.

6. A printing system according to claim 4, wherein said connection includes an electrical power link between said base unit and said printing device.

7. A printing system according to claim 4, wherein said base unit includes an ink supply device for said at least one printhead and said connection includes a tube for conveying ink from said ink supply device of said base unit to said at least one printhead.

8. A printing system according to claim 4, wherein said base unit includes an air flow device, said air flow device producing a flow of air and said printing device includes an arrangement of orifices and walls whereby an air cushion is produced around said at least one printhead, said connection including a tube for conveying air from said base unit to said arrangement.

9. A printing system according to claim 4, wherein a part of said connection constitutes a manual holding device for said printing device.

10. A printing system according to claim 1, wherein said printing device includes a switch arrangement for initiating a position sensing operation and for starting and stopping a printing operation.

11. A printing system for providing an image on a surface, said system comprising at least one printhead moveable over said surface, a monitoring arrangement, said monitoring arrangement being arranged to monitor the position of said printhead as it passes over said surface, and a controller, said controller being connected to said position monitor and being arranged to control operation of said printhead whereby said printhead only prints on regions of said surface where printing of said image has not yet been completed.

12. A printing system according to claim 11 comprising a stationary base unit and a printing device moveable relative thereto and carrying said printhead.

13. A printing device according to claim 12, wherein said monitoring arrangement comprises an emitter arrangement and a receiver arrangement, one of said emitter arrangement and said receiver arrangement being mounted on said base unit and the other of said emitter arrangement and said receiver arrangement being mounted on said moveable member, the position of said printhead as it passes over said surface being determined by interferometry.

14. A method of printing an image on a surface by passing at least one printhead over said surface, monitoring the position of said printhead as it is passed over said surface, and controlling operation of said printhead so that it prints when it is at a location where printing of said image has not yet been completed but does not print when it is at a location where printing of said image has been completed.

15. A method according to claim 14, wherein both the location and the orientation of said printhead are taken into account when controlling its operation.

16. A method according to claim 14, wherein the position of said printhead is monitored by means of interferometry.

17. A method according to claim 13, wherein at least one region of said image is printed in a plurality of passes of said printhead, printing of a part of said image in said region occurring during a first pass of said printhead thereover and printing of one or more subsequent parts of said image in said region occurring in respective subsequent passes of said printhead thereover.

18. A method according to claim 14 wherein a printing device comprising a plurality of printheads is passed over said surface, printing by a first of said printheads occurring during a first pass over a region of said surface and printing by one or more further printheads occurring during respective subsequent passes over said region.

19. A method according to claim 14, wherein, in a first phase, a first printing device with at least one printhead is passed over at least part of said surface to be printed to print part of the image and, in a second phase, a second printing device with at least one printhead is passed over at least part of the surface to be printed to print part of the image not printed by said first printing device during the first phase.

20. A method according to claim 19, wherein said second printing device is smaller than said first printing device.

21. A method according to claim 19, wherein a common control is used for said first and second printheads.

22. A printing system for printing an image on a surface, the system comprising at least first and second printing devices moveable over said surface at different times, means for monitoring the position of each printing device as it passes over said surface, and control means connected to said position monitoring means and controlling operation of said printing devices so that, in a first phase, said first printing device is passed over at least part of said surface to be printed to print part of the image and, in a second phase, said second printing device is passed over at least part of the surface to be printed to print part of the image.

23. A movable device comprising a print zone including at least one printhead, a first barrier surrounding said print zone, a second barrier spaced from and surrounding said first barrier to form a region between said first and second barriers, and an air supply device, said air supply device being arranged to supply pressurized air to said region whereby to produce an air cushion capable of maintaining said printing device at a substantially constant distance from a surface to be printed.
